(19) United States
(12) Patent Application Publication
(10) Pub. No.: US 2024/0037589 A1
(43) Pub. Date: Feb. 1, 2024

(54) SERVER AND SYSTEM

(71) Applicant: TOYOTA JIDOSHA KABUSHIKI KAISHA, Toyota-shi (JP)

(72) Inventors: Takashi MATSUMOTO, Toyota-shi (JP); Keiko HASEGAWA, Toyota-shi (JP); Masashi TAKAHASHI, Nagoya-shi (JP); Tohru NAKAMURA, Toyota-shi (JP); Ai MIYATA, Sakai-shi (JP)

(73) Assignee: TOYOTA JIDOSHA KABUSHIKI KAISHA, Toyota-shi (JP)

(21) Appl. No.: 18/333,146

(22) Filed: Jun. 12, 2023

(30) Foreign Application Priority Data
Aug. 1, 2022 (JP) 2022-122792

(51) Int. Cl. G06Q 30/0207; G06Q 10/02; B60L 53/66; B60L 53/68

(52) U.S. Cl. CPC G06Q 30/0207; G06Q 10/02; B60L 53/665; B60L 53/68

(57) ABSTRACT

A server includes a determination unit that determines a state of congestion at an EVSE unit by a plurality of electrified vehicles responding to a request for execution of electric power control, and a setting unit that sets an incentive for each of the electrified vehicles to perform the electric power control at another EVSE unit when the determination unit determines that congestion is occurring at the EVSE unit.

### CROSS-REFERENCE TO RELATED APPLICATION

This application claims priority to Japanese Patent Application No. 2022-122792 filed on Aug. 1, 2022, incorporated herein by reference in its entirety.

### BACKGROUND

### 1. Technical Field

The present disclosure relates to a server and a system.

### 2. Description of Related Art

A charging processing system described in Japanese Unexamined Patent Application Publication No. 2020-102025 (JP 2020-102025 A), for example, includes a power feeding facility capable of supplying CO₂-free electric power generated using renewable energy, and a server. The server issues coupons, which can be used at shops in the vicinity of the power feeding facility, to users of electrified vehicles performing CO₂-free charging.

### SUMMARY

However, in JP 2020-102025 A described above, coupons that can be used at shops in the vicinity of the power feeding facility are issued to users of electrified vehicles performing CO₂-free charging, and accordingly it is conceivable that congestion of electrified vehicles intending to perform CO₂-free charging will occur at the power feeding facility. Therefore, it is desirable to suppress congestion from occurring at power feeding facilities (charging stations) by electrified vehicles.

The present disclosure has been made to solve the above problems, and it is an object thereof to provide a server and a system capable of suppressing congestion from occurring at charging stations by electrified vehicles.

A server according to a first aspect of the present disclosure is a server that manages a first charging station, and at least one second charging station that are different from each other. Each of the first charging station and the second charging station is configured to be able to perform electric power control including at least one of power feeding to an electric power grid and charging from the electric power grid. The server includes a determination unit that determines a state of congestion at the first charging station by a plurality of electrified vehicles responding to a request for execution of electric power control, and a setting unit that sets an incentive for each of the electrified vehicles to perform the electric power control at the second charging station when the determination unit determines that congestion is occurring at the first charging station.

In the server according to the first aspect of the present disclosure, as described above, when the determination unit determines that congestion is occurring at the first charging station, an incentive is set for each of the electrified vehicles to perform the electric power control at the second charging station. Thus, the number of users of electrified vehicles who will perform electric power control at the second charging station for the purpose of the above incentive (users who change the location of performing of electric power control from the first charging station to the second charging station) can be increased. As a result, congestion at the first charging station by electrified vehicles can be suppressed.

Also, the server according to the first aspect preferably includes a first acquisition unit that acquires position information of each of the electrified vehicles. The determination unit determines a state of congestion at the first charging station based on the position information of each of the electrified vehicles acquired by the first acquisition unit. According to this configuration, the number of electrified vehicles in the vicinity of the first charging station can be easily detected based on the position information of each of the electrified vehicles. As a result, the state of congestion at the first charging station can be easily determined.

Also, the server according to the first aspect preferably includes a second acquiring unit that acquires reservation information regarding a state of reservation for the electric power control at the first charging station by each of the electrified vehicles. The determination unit determines a state of congestion at the first charging station based on the reservation information. According to this configuration, the number of electrified vehicles in the vicinity of the first charging station can be easily predicted based on the reservation information. As a result, the state of congestion at the first charging station can be easily determined.

Further, in the server according to the first aspect, preferably, when the second charging station is installed in a vicinity of a parking lot, the setting unit sets an incentive to grant a free-parking voucher that is able to be used in the parking lot. According to this configuration, a greater number of users who plan to use the parking lot can be led to perform electric power control at the second charging station.

Also, in the server according to the first aspect, preferably, a plurality of the second charging stations is provided. When the determination unit determines that congestion is occurring at the first charging station, the setting unit sets the incentive to perform electric power control at the second charging station that is closest to the first charging station out of the second charging stations. According to this configuration, the time necessary to go from the first charging station to the second charging station is shortened, and accordingly the number of users who change the location of performing electric power control from the first charging station to the second charging station can be increased.

Also, in the server according to the first aspect, preferably, a plurality of the second charging stations is provided. When the determination unit determines that congestion is occurring at the first charging station, the setting unit sets the incentive to perform electric power control at the second charging station of which a frequency of performing the electric power control is lowest out of the second charging stations. According to this configuration, a state in which the frequency of performing electric power control at the second charging station is low can be resolved.

A system according to a second aspect of the present disclosure includes a first charging station and a second charging station that are different from each other, and a server that manages the first charging station and the second charging station. Each of the first charging station and the second charging station is configured to be able to perform electric power control including at least one of power feeding to an electric power grid and charging from the electric power grid. The server determines a state of congestion at the first charging station by a plurality of electrified vehicles responding to a request for execution of electric power control, and sets an incentive for each of the electrified vehicles to perform the electric power control at the second charging station when determination is made that congestion is occurring at the first charging station.

In the server according to the second aspect of the present disclosure, as described above, when determination is made that congestion is occurring at the first charging station, the incentive is set for each of the electrified vehicles to perform the electric power control at the second charging station. Thus, a system that is capable of suppressing congestion at the first charging station by electrified vehicles can be provided.

According to the present disclosure, congestion at charging stations by electrified vehicles can be suppressed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of a system according to a first embodiment;

FIG. 2 is a diagram illustrating a region in which a state of congestion at electric vehicle supply equipment (EVSE) units is determined in the first embodiment;

FIG. 3 is a sequence diagram of the system according to the first embodiment;

FIG. 4 is a diagram illustrating a configuration of a system according to a second embodiment;

FIG. 5 is a sequence diagram of the system according to the second embodiment;

FIG. 6 is a diagram illustrating a configuration of a system according to a third embodiment;

FIG. 7 is a sequence diagram of the system according to the third embodiment; and

FIG. 8 is a diagram illustrating a server according to a modification of the first to third embodiments.

### DETAILED DESCRIPTION OF EMBODIMENTS

Embodiments of the present disclosure will be described below in detail with reference to the drawings. In the drawings, the same or corresponding parts are denoted by the same signs, and description thereof will not be repeated.

### First Embodiment

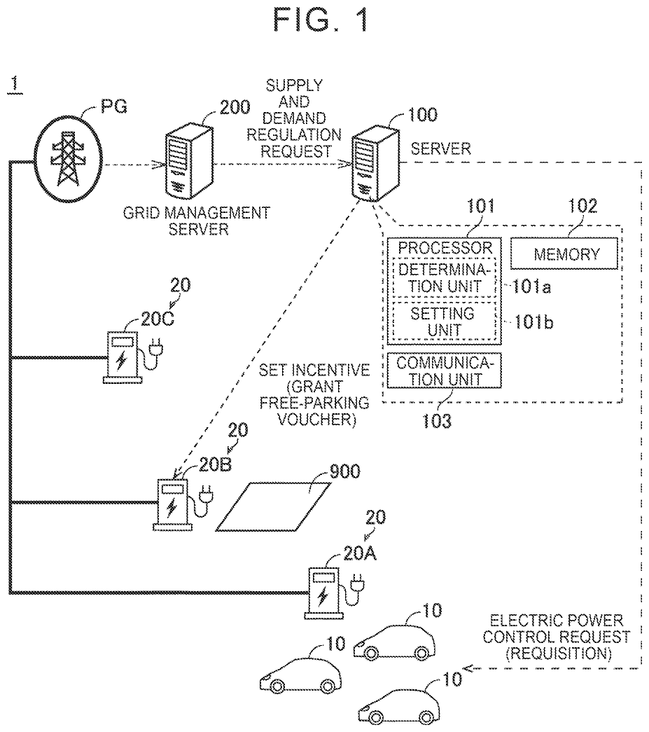

FIG. 1 is a diagram illustrating a configuration of a system 1 according to a first embodiment. The system 1 includes an electric power grid PG, a server 100, a grid management server 200, a plurality of electrified vehicles 10, and a plurality of electric vehicle supply equipment (EVSE) units 20. The server 100 is a server that manages each of the EVSE units 20. In addition, the server 100 manages electric power control by the electrified vehicles 10, which will be described later.

The EVSE units 20 include an EVSE unit 20A, an EVSE unit 20B, and an EVSE unit 20C. Note that the EVSE unit 20A is an example of “first charging station” 10 according to the present disclosure. Also, each of the EVSE unit 20B and the EVSE unit 20C is an example of “second charging station” according to the present disclosure. Note that the number of EVSE units 20 in the system 1 may be three or more.

Each EVSE unit 20 is capable of feeding electric power to the electric power grid PG (external power feeding) and charging from the electric power grid PG (external charging). In other words, each of the electrified vehicles 10 is capable of external power feeding and external charging via each of the EVSE units 20. Hereinafter, the above-described external power feeding and external charging will be referred to collectively as “electric power control”. The electrified vehicles 10 include, for example, plug-in hybrid electric vehicles (PHEVs), battery electric vehicles (BEVs), and fuel cell electric vehicles (FCEVs).

The electric power grid PG is an electrical power network made up of power plants and power transmission and distribution facilities, neither of which is illustrated. In the first embodiment, an electric power company serves as both a power generation business operator and a power transmission and distribution business operator. The electric power company corresponds to a general power transmission and distribution business operator, and maintains and manages the electric power grid PG. The electric power company is equivalent to a manager of the electric power grid PG.

The grid management server 200 manages supply and demand on the electric power grid PG (power grid). Also, the grid management server 200 belongs to the electric power company. The grid management server 200 transmits requests for regulation of the electric power demand amount on the electric power grid PG (supply and demand regulation requests) to the server 100, based on the electric power generation and consumption of each electric power regulating resource managed by the grid management server 200. Specifically, when the electric power generation amount or electric power consumption amount of the electric power regulating resources is foreseen to be greater than what is usual therefor (or is greater at the current point in time), the grid management server 200 transmits a request to the server 100 to increase or reduce the electric power demand amount more than what is usual therefor.

The server 100 is a server managed by an aggregator. An aggregator is an electric utility that aggregates a plurality of the electric power regulating resources in a region, a predetermined facility, or the like, and provides energy management services.

The server 100 requests (requisitions) the electrified vehicles 10 to perform electric power control, as one way to increase or reduce the electric power demand amount on the electric power grid PG. The server 100 transmits a request signal for making the above request to the electrified vehicles 10, to the electrified vehicles 10 or to mobile terminals (omitted from illustration) or the like that are owned by users of the electrified vehicles 10.

The server 100 is also configured to manage information regarding the electrified vehicles 10 that are registered (hereinafter, also referred to as “vehicle information”), information regarding each user that is registered (hereinafter, also referred to as “user information”), and information regarding each EVSE unit 20 that is registered (hereinafter, also referred to as “EVSE information”). The user information, the vehicle information, and the EVSE information are distinguished by identification information (IDs) and stored in memory 102 of the server 100.

A user ID is identification information for identifying users, and also functions as information for identifying a mobile terminal (omitted from illustration) that is carried by the user (terminal ID). The server 100 is configured to distinguish and store information received from mobile terminals for each of the user IDs. The user information includes a communication address of the mobile terminal carried by the user, and a vehicle ID of the electrified vehicle 10 belonging to the user.

The vehicle ID is identification information for identifying the electrified vehicle 10. The vehicle ID may be a license plate number or may be a vehicle identification number (VIN). The vehicle information includes an operation schedule of each electrified vehicle 10.

An EVSE-ID is identification information for identifying each EVSE unit EVSE information includes a communication address of each EVSE unit 20 and the state of the electrified vehicles 10 connected to each EVSE unit 20. The EVSE information also includes information indicating a combination of the electrified vehicle 10 and the EVSE unit 20 connected to each other (e.g., a combination of EVSE-ID and vehicle ID).

The server 100 includes a processor 101, the memory 102, and a communication unit 103. Note that the communication unit 103 is an example of “first acquisition unit” according to the present disclosure.

The memory 102 stores, in addition to programs to be executed by the processor 101, information to be used in the programs (e.g., maps, mathematical expressions, and various types of parameters). The communication unit 103 includes various types of communication interfaces. The processor 101 controls the communication unit 103.

The communication unit 103 is capable of communicating with the grid management server 200, the electrified vehicles 10, and the EVSE units 20.

The processor 101 includes a determination unit 101a and a setting unit 101b. Note that the determination unit 101a and the setting unit 101b each represents software in which functional features of the processor 101 are represented in the form of blocks.

Now, in a conventional system, there are cases in which congestion occurs at the EVSE units by electrified vehicle regarding which performing of electric power control is scheduled. Accordingly, suppressing congestion of the EVSE units by electrified vehicles is desirable.

To this end, the processor 101 (determination unit 101a) of the server 100 determines the state of congestion of the electrified vehicles 10 at the EVSE unit 20A (the state of congestion at the EVSE unit 20A by the electrified vehicles 10), in response to (acceptance of) the request (requisition) for electric power control.

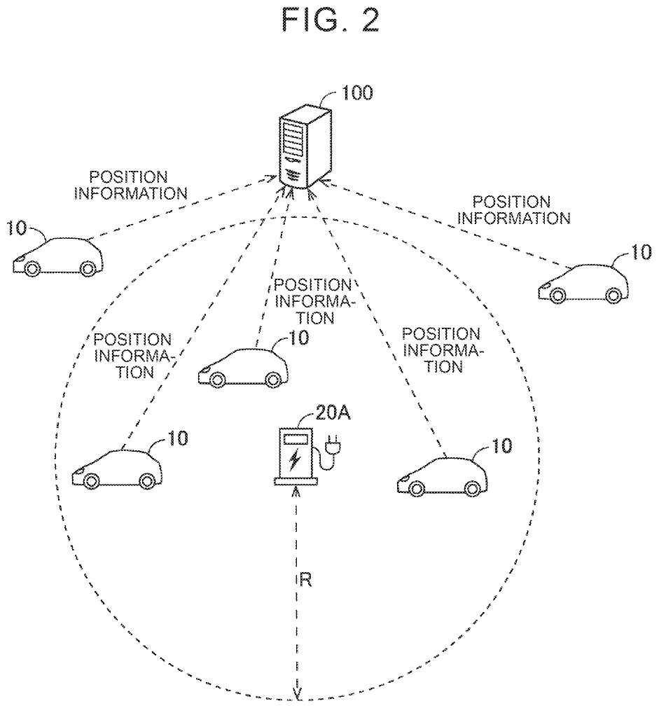

Specifically, as illustrated in FIG. 2, the server 100 (communication unit 103) acquires position information from each of the electrified vehicles 10 in response to the electric power control request (requisition) through communication. Also, the processor 101 calculates the number of electrified vehicles 10 within a radius R (e.g., 100 m) from the EVSE unit 20A, for example, based on the position information that is acquired. The processor 101 (determination unit 101a) then determines that congestion is occurring at the EVSE unit 20A when the calculated number of vehicles is no less than a predetermined threshold value (e.g., 10 vehicles).

Note that the processor 101 (determination unit 101a) may determine the congestion state at the EVSE unit 20A based on a comparison between the average number of electrified vehicles 10 over a predetermined time period (e.g., one hour) and the predetermined threshold value.

Referring to FIG. 1 again, when determination is made that there is congestion at the EVSE unit 20A, the processor 101 (setting unit 101b) of the server 100 sets an incentive for each of the electrified vehicles 10 to perform electric power control at the EVSE unit 20B.

For example, an assumption will be made that the EVSE unit 20B is installed in the vicinity of a parking lot 900. In this case, the incentive includes granting free-parking vouchers, which can be used at the parking lot 900, to the users of the electrified vehicles 10 that performed electric power control at the EVSE unit 20B. Note that, for example, the duration for free parking that is permitted by the free-parking voucher may be regulated based on the degree of contribution (charging/discharging time, charging/discharging amount, etc.) of the electric power control. Note that the EVSE unit may be an EVSE unit installed in a parking lot for a facility such as an event venue, a shopping mall, or the like, at which the duration of the parking time tends to be relatively long.

As another example, an assumption will be made that the EVSE unit 20B is installed near a shop, which is omitted from illustration. In this case, the incentive may include granting a coupon, which can be used at the shop, to the users of the electrified vehicles 10 that performed electric power control at the EVSE unit 20B. As yet another example, the incentive may include granting points, which can be used for predetermined

Web services or the like, to the users of the electrified vehicles 10 that performed electric power control at the EVSE unit 20B.

Further, when determination is made that congestion is occurring at the EVSE unit 20A, the processor 101 (setting unit 101b) sets the above incentive for electric power control to the EVSE unit 20B, which is closest to the EVSE unit 20A among the EVSE unit 20B and the EVSE unit 20C. Specifically, the memory 102 of the server 100 stores information regarding distances among the EVSE units 20. Based on the information stored in the memory 102, the processor 101 (setting unit 101b) decides the EVSE unit 20B to be the object to which the incentive is set.

Note that at this time, when the processor 101 (the setting unit 101b) determines (by the determination unit 101a) that congestion is occurring at the EVSE unit 20B as well, the processor 101 (the setting unit 101b) may set an incentive for electric power control at the EVSE unit 20C.

### Incentive Setting Method

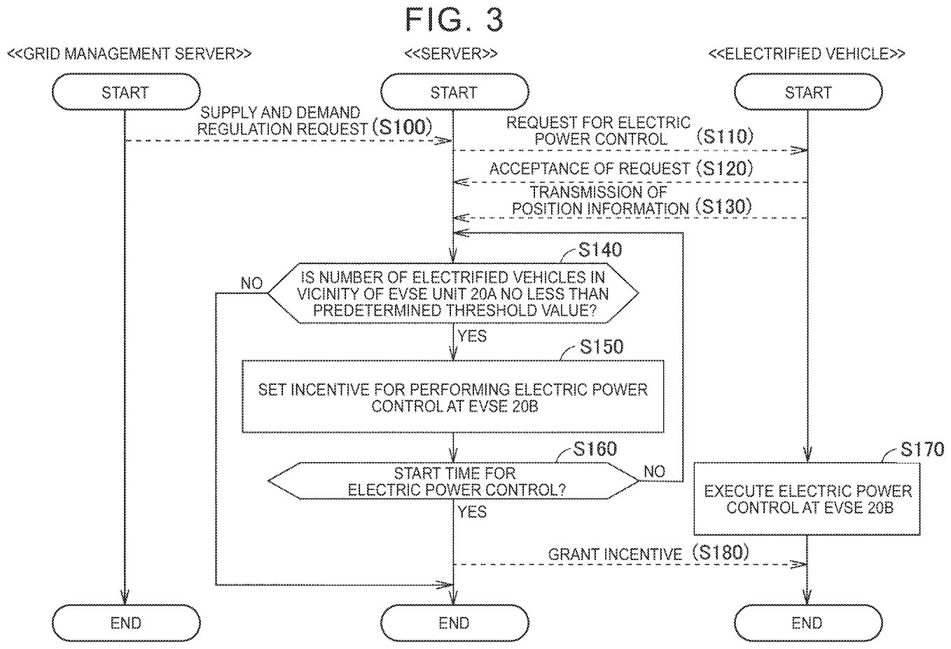

Next, a method for setting the incentive will be described with reference to a sequence diagram in FIG. 3.

### Transmission of Supply and Demand Regulation Request: Grid Management Server

First, in step S100, the grid management server 200 transmits a request (supply and demand regulation request) for adjusting the electric power demand amount of the electric power grid PG to the server 100 (communication unit 103).

### Electric Power Control Request: Server

Next, in step S110, the server 100 (communication unit 103) makes a request (requisition) for electric power control to each of the electrified vehicles 10, based on the supply and demand regulation request transmitted to the server 100 in step S100.

### Acceptance of Electric Power Control Request: Electrified Vehicle

Next, assumption will be made that in step S120, each of the electrified vehicles 10 accepts the electric power control requested in step S110.

### Transmission of Position Information: Electrified Vehicle

Next, in step S130, each of the electrified vehicles 10 that accepted the electric power control request in step S120 transmits its own position information to the server 100 (communication unit 103). It should be noted that the process of step S130 may be repeatedly performed a plurality of times until a start time, which will be described later. Also, the server 100 (communication unit 103) may constantly acquire (receive) the position information of each (all) of the electrified vehicles 10 managed thereby.

### Determination of State of Congestion: Server

Next, in step S140, the processor 101 (determination unit 101a) of the server 100 determines the state of congestion of the electrified vehicles 10 at the EVSE unit 20A. Specifically, the processor 101 (determining unit 101a) determines whether the number of electrified vehicles 10 (that have accepted electric power control) within the radius R (see FIG. 2) of the EVSE unit 20A is no less than a predetermined threshold value (e.g., 10 vehicles). When the number of electrified vehicles 10 is no less than the predetermined threshold value (Yes in step S140), determination is made that congestion is occurring at the EVSE unit 20A, and the flow advances to step S150. When the number of electrified vehicles 10 is less than the predetermined threshold value (No in step S140), determination is made that congestion is not occurring at the EVSE unit 20A, and the flow ends.

### Setting of Incentives: Server

Next, in step S150, the processor 101 (setting unit 101b) of the server 100 sets the incentive for performing electric power control at the EVSE unit 20B installed closest to the EVSE unit 20A.

### Determination of Whether Time to Start Electric Power Control: Server

Next, in step S160, the processor 101 of the server 100 determines whether the current time is the start time for electric power control (the time at which electric power control has been agreed to be performed). The current time being the start time may include that the current time is within a predetermined duration of time (e.g., 10 minutes) before or after the start time. When determination is made that the current time is the start time (Yes in S160), the flow advances to step S170. When determination is made that the current time is not the start time (No in S160), the flow returns to step S140.

### Execution of Electric Power Control: Electrified Vehicle

Next, assumption will be made that the electrified vehicle 10 performs electric power control at the EVSE unit 20B in step S170.

### Granting of Incentives: Server

Next, in step S180, the server 100 (processor 101) performs control to grant the incentive to the user of the electrified vehicle 10 for which electric power control was performed in step S170. For example, the server 100 (communication unit 103) may transmit a digital free-parking voucher to the electrified vehicle 10, the mobile terminal of the user, or the like, as an incentive.

As described above, in the first embodiment, the server 100 sets an incentive for performing electric power control at the EVSE unit 20B when determination is made that the EVSE unit 20A is congested. Accordingly, a great number of electrified vehicles 10 can be suppressed from becoming concentrated at the EVSE unit 20A. Also, the frequency of performing electric power control at the EVSE unit 20B can be improved. Also, acquiring the position information of each electrified vehicle 10 enables the state of congestion at the EVSE unit 20A to be determined in real time.

### Second Embodiment

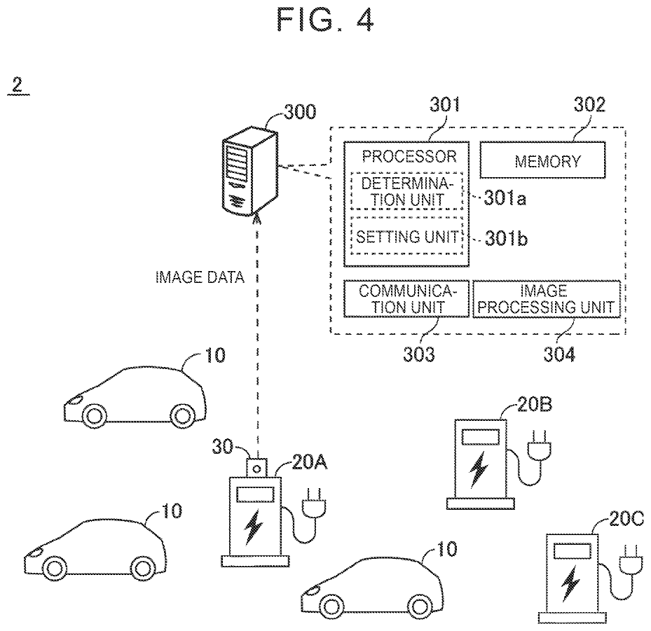

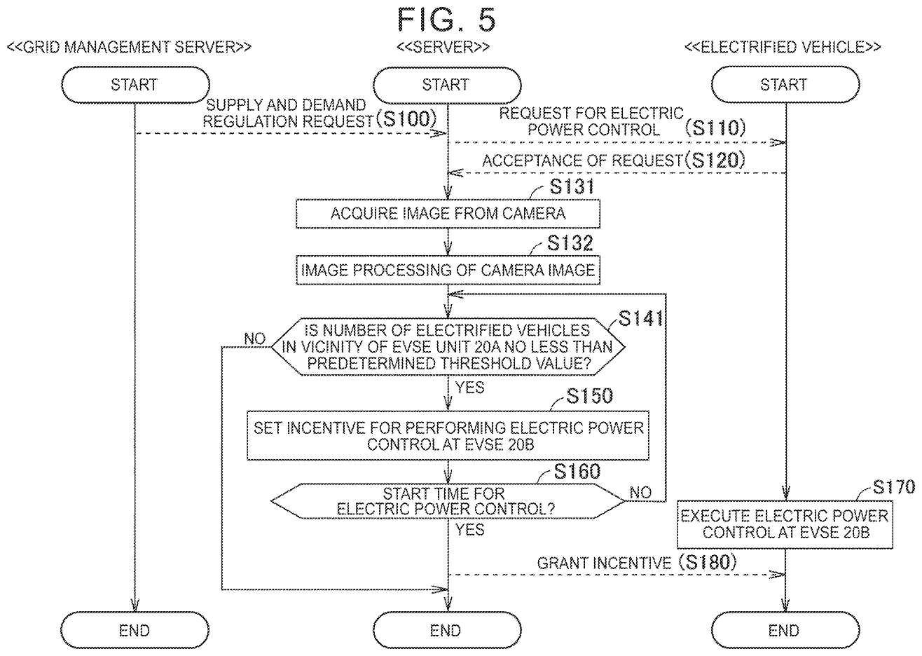

Next, a second embodiment of the present disclosure will be described with reference to FIGS. 4 and 5. Unlike in the first embodiment, in which the state of congestion of the electrified vehicles 10 is determined based on the position information transmitted from the electrified vehicles 10, the state of congestion of the electrified vehicles 10 is determined based on images acquired by a camera 30 in the second embodiment. It should be noted that configurations the same as those in the first embodiment are denoted by the same signs, and description thereof will not be repeated.

A system 2 according to the second embodiment includes a server 300 and the camera 30. The server 300 includes a processor 301, memory 302, a communication unit 303, and an image processing unit 304. Note that the communication unit 303 is an example of “first acquisition unit” according to the present disclosure. The processor 301 includes a determination unit 301a and a setting unit 301b. Note that the determination unit 301a and the setting unit 301b each represents software in which functional features of the processor 301 are represented in the form of blocks.

Also, the camera 30 is installed near the EVSE unit 20A. In the example illustrated in FIG. 4, the camera 30 is installed on the EVSE unit 20A. The camera 30 captures (acquires) images of the surroundings the EVSE unit 20A. The camera 30 then transmits acquired image data to the server 300 (communication unit 303).

The image processing unit 304 of the server 300 performs image processing on the image data acquired by the communication unit 303. The image processing unit 304 identifies the electrified vehicles 10 in the image data that is subjected to image processing. Specifically, the image processing unit 304 identifies, based on the vehicle information (vehicle number, etc.) of the electrified vehicles 10, that the electrified vehicles 10 included in the image data are the electrified vehicles 10 that have accepted electric power control. Note that the image processing unit 304 may identify the electrified vehicles 10 using artificial intelligence (AI) or the like, for example.

Based on the number of electrified vehicles 10 identified by the image processing unit 304, the processor 301 (determining unit 301a) determines whether congestion is occurring at the EVSE unit 20A. For example, the processor 301 (determination unit 301a) determines that congestion is occurring at the EVSE unit 20A when the number of electrified vehicles 10 identified is no less than a predetermined threshold value (e.g., three vehicles).

Note that the processor 301 (determination unit 301a) may determine the congestion state at the EVSE unit 20A based on a comparison between the average number of electrified vehicles 10 in a plurality of pieces of image data acquired over a predetermined time period (e.g., one hour) and the predetermined threshold value.

### Incentive Setting Method

Next, a method for setting the incentive will be described with reference to a sequence diagram in FIG. 5.

### Acquisition of Camera Image: Server

In step S131 following step S120, the server 300 (communication unit 303) acquires image data from the camera 30. Note that the server 300 (communication unit 303) may constantly receive image data from the camera 30.

Image processing of Camera Image: Server

Next, in step S132, the server 300 (image processing unit 304) performs image processing on the image data acquired in step S131. The server 300 (image processing unit 304) then identifies the electrified vehicles 10 that have accepted electric power control in the image data subjected to image processing. Note that the process of steps S131 and S132 may be repeated a plurality of times until the start time of electric power control.

### Determination of State of Congestion: Server

Next, in step S141, the processor 301 (determination unit 301a) of the server 300 determines the state of congestion of the electrified vehicles 10 at the EVSE unit 20A. Specifically, processor 301 (determining unit 301a) determines whether the number of electrified vehicles 10 included in the image data (that accepted electric power control) is no less than a predetermined threshold value (for example, 3 vehicles). When the number of electrified vehicles 10 is no less than the predetermined threshold value (Yes in step S141), determination is made that congestion is occurring at the EVSE unit 20A, and the flow advances to step S150. When the number of electrified vehicles 10 is less than the predetermined threshold value (No in step S141), determination is made that congestion is not occurring at the EVSE unit 20A, and the flow ends. Note that when No in step S160, the processing returns to step S141.

As described above, in the second embodiment, the server 300 determines the state of congestion at the EVSE unit 20A based on images of the camera 30. Accordingly, the server 300 (communication unit 303) can perform the above determination without receiving position information from each of the electrified vehicles 10 through communication. As a result, the communication load on the server 300 can be reduced.

### Third Embodiment

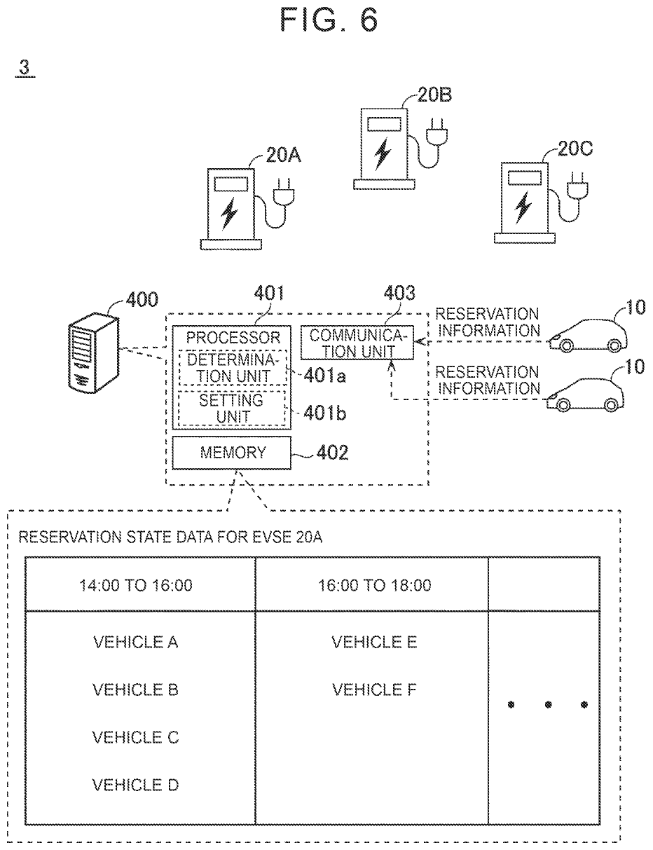

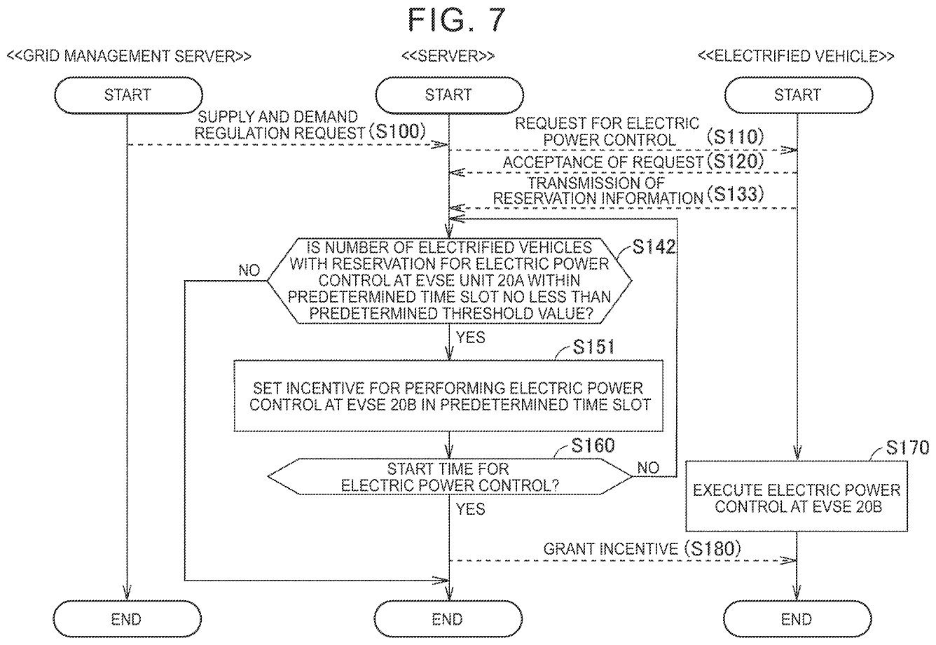

Next, a third embodiment of the present disclosure will be described with reference to FIGS. 6 and 7. In the third embodiment, unlike the first and second embodiments in which the state of congestion of the electrified vehicles 10 is determined based on the position information of the electrified vehicles 10, the state of congestion of the electrified vehicles 10 is determined based on a state of reservations for electric power control. It should be noted that configurations the same as those in the first and second embodiments are denoted by the same signs, and description thereof will not be repeated.

A system 3 according to the third embodiment includes a server 400. The server 400 includes a processor 401, memory 402, and a communication unit 403. Note that the communication unit 403 is an example of “second acquisition unit” according to the present disclosure.

The processor 401 includes a determination unit 401a and a setting unit 401b. Note that the determination unit 401a and the setting unit 401b each represents software in which functional features of the processor 401 are represented in the form of blocks.

Now, the communication unit 403 acquires reservation information regarding the state of reservations for electric power control at the EVSE unit 20A, by each of the electrified vehicles 10. For example, the communication unit 403 acquires the reservation information from each of the electrified vehicles 10 through communication. Note that the server 400 may acquire (download) reservation information of each electrified vehicle 10 stored in the cloud or the like.

Based on the acquired reservation information, the processor 401 creates data indicating the state of reservations for electric power control at the EVSE unit 20A (hereinafter referred to as reservation state data). The reservation state data is stored in the memory 402.

In the example of reservation state data illustrated in FIG. 6, four electrified vehicles 10 (referred to as vehicles A, B, C, and D to distinguish therebetween) have reservations for electric power control at the EVSE unit 20A between 14:00 and 16:00.Also, two electrified vehicles 10 (referred to as vehicles E and F to distinguish therebetween) have reservations for electric power control at the EVSE unit 20A between 16:00 and 18:00.

The processor 401 (determining unit 401a) of the server 400 determines the state of congestion at the EVSE unit 20A based on the reservation information. For example, the processor 401 (determining unit 401a) determines that a time slot in which the number of vehicles with reservations in the reservation state data is no less than a predetermined threshold value (e.g., three vehicles) is a time slot in which congestion is occurring at the EVSE unit 20A. Specifically, in the example illustrated in FIG. 6, the processor 401 (determination unit 401a) determines that the period between 14:00 and 16:00 is a time slot in which congestion is occurring at the EVSE unit 20A, since the number of electrified vehicles 10 with reservations for electric power control is four, which is not less than the predetermined threshold value. On the other hand, the processor 401 (determining unit 401a) determines that the period between 16:00 and 18:00 is a time slot in which congestion is not occurring at the EVSE unit 20A, since the number of electrified vehicles 10 with reservations for electric power control is two, which is less than the predetermined threshold value.

### Incentive Setting Method

Next, a method for setting the incentive will be described with reference to a sequence diagram in FIG. 7.

### Transmission of Reservation Information: Server

In step S133 following step S120, each of the electrified vehicles 10 transmits reservation information for electric power control at the EVSE unit 20A to the communication unit 403 of the server 400. Note that the process of step S133 is continuously performed until the start time of electric power control.

### Determination of State of Congestion: Server

Next, in step S142, the processor 401 of the server 400 creates reservation state data (see FIG. 6) based on the reservation information of each electrified vehicle 10 acquired in step S133. The processor 401 (determination unit 401a) then determines whether the number of vehicles with reservations in a predetermined time slot (e.g., between 14:00 and 16:00) is no less than a predetermined threshold value, based on the reservation state data. When the number of vehicles with reservations is no less than the predetermined threshold value (Yes in S142), determination is made that the EVSE unit 20A is congested during the predetermined time slot, and the processing advances to step S151. When the number of vehicles with reservations is less than the predetermined threshold value (No in S142), determination is made that the EVSE unit 20A is not congested during the predetermined time slot, and the processing ends. Note that when determination of No is made in step S160, the processing returns to step S142.

### Setting of Incentives: Server

Next, in step S151, the processor 401 (setting unit 401b) of the server 400 sets an incentive for the EVSE unit 20B provided closest to the EVSE unit 20A, with respect to performing electric power control at the EVSE unit 20B during the predetermined time slot. The processing then advances to step S160.

As described above, in the third embodiment, the server 400 determines the state of congestion at the EVSE unit 20A based on the state of reservations for electric power control at the EVSE unit 20A. Thus, the number of electrified vehicles 10 scheduled to perform electric power control at the EVSE unit 20A can be accurately detected, and accordingly the state of congestion at the EVSE unit 20A can be determined more accurately. Also, acquiring the reservation information for electric power control of each electrified vehicle 10 enables the state of congestion at the EVSE unit 20A to be detected in advance.

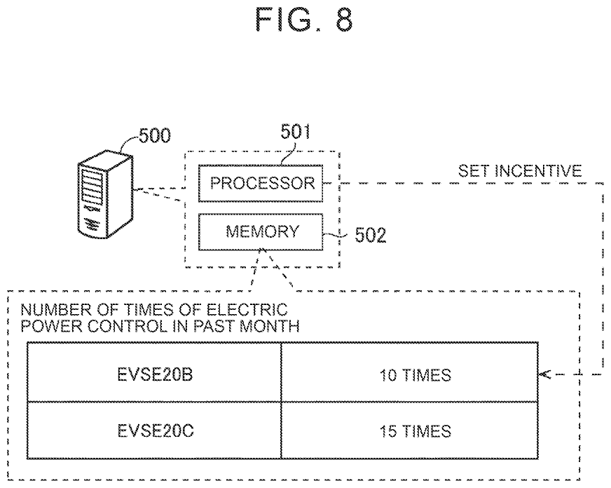

In the above-described first to third embodiments, an example has been described in which the EVSE unit 20B provided closest to the EVSE unit 20A is decided to be the object to which the incentive is set, but the present disclosure is not limited to this. For example, objects of setting incentives may be decided based on the frequency at which electric power control is performed at each EVSE unit 20. Specifically, as illustrated in FIG. 8, a server 500 includes a processor 501 and memory 502. The memory 502 stores the number of times of performing electric power control during a predetermined period (e.g., the past month) at each of the EVSE unit 20B and the EVSE unit 20C. Now, when 30 determination is made that congestion is occurring at the EVSE unit 20A, the processor 501 decides the EVSE unit 20B, which has the lowest frequency of performing electric power control, as the object for which the incentive is set.

Also, when determination is made that congestion is occurring at the EVSE unit 20A, the EVSE unit 20 that is determined to be the least congested among the other EVSE units 20 may be decided to be the object for which the incentive is set. Note that the state of congestion at the other EVSE units 20 may be determined in the same way as the determination of the state of congestion of the EVSE unit 20A in the first to third embodiments.

Further, in the above-described first to third embodiments, an example has been described in which the electrified vehicles 10 can execute external charging and external power feeding at the EVSE units 20, but the present disclosure is not limited to this. An arrangement may be made in which the electrified vehicles 10 are capable of executing only one of external charging and external power feeding at the EVSE units 20.

Also, in the above-described first to third embodiments, an example has been described in which the server 100 (300, 400) requests the electrified vehicles 10 to perform electric power control, and determines the state of congestion at the EVSE units 20 (and sets incentives), but the present disclosure is not limited to this. A server that requests the electrified vehicles 10 to perform electric power control, and a server that determines the state of congestion at the EVSE units 20 (and sets incentives) may be provided separately from each other.

Also, in the above-described first to third embodiments, an example has been described in which the state of congestion at the EVSE unit 20A is determined, but the present disclosure is not limited to this. The state of congestion at the EVSE units 20 other than the EVSE unit 20A (e.g., EVSE unit 20B and EVSE unit 20C) may be determined.

Further, in the first and second embodiments described above, an example has been described in which the communication unit 103 (303) acquires the position information (image data of the camera 30) of the electrified vehicles 10 through communication, but the present disclosure is limited to this. For example, the server 100 (300) may acquire (download) the position information and the image data stored in the cloud or the like.

The embodiment disclosed herein should be considered to be exemplary and not restrictive in all respects. The scope of the present disclosure is set forth by the claims rather than by the above description of the embodiments, and is intended to include all modifications within the meaning and scope equivalent to the claims.

What is claimed is:

1. A server that manages a first charging station, and at least one second charging station that are different from each other, wherein each of the first charging station and the second charging station is configured to be able to perform electric power control including at least one of power feeding to an electric power grid and charging from the electric power grid,
the server comprising:
a determination unit that determines a state of congestion at the first charging station by a plurality of electrified vehicles responding to a request for execution of the electric power control; and
a setting unit that sets an incentive for each of the electrified vehicles to perform the electric power control at the second charging station when the determination unit determines that congestion is occurring at the first charging station.

2. The server according to claim 1, further comprising a first acquisition unit that acquires position information of each of the electrified vehicles, wherein the determination unit determines a state of congestion at the first charging station based on the position information of each of the electrified vehicles acquired by the first acquisition unit.

3. The server according to claim 1, further comprising a second acquisition unit that acquires reservation information regarding a state of reservation for the electric power control at the first charging station by each of the electrified vehicles, wherein the determination unit determines a state of congestion at the first charging station based on the reservation information.

4. The server according to claim 1, wherein, when the second charging station is installed in a vicinity of a parking lot, the setting unit sets the incentive to grant a free-parking voucher that is able to be used in the parking lot.

5. The server according to claim 1, wherein:
a plurality of the second charging stations is provided; and
when the determination unit determines that congestion is occurring at the first charging station, the setting unit sets the incentive to perform the electric power control at the second charging station that is closest to the first charging station out of the second charging stations.

6. The server according to claim 1, wherein:
a plurality of the second charging stations is provided; and
when the determination unit determines that congestion is occurring at the first charging station, the setting unit sets the incentive to perform the electric power control at the second charging station of which a frequency of performing the electric power control is lowest out of the second charging stations.

7. A system comprising:
a first charging station and a second charging station that are different from each other; and
a server that manages the first charging station and the second charging station, wherein:
each of the first charging station and the second charging station is configured to be able to perform electric power control including at least one of power feeding to an electric power grid and charging from the electric power grid; and
the server
determines a state of congestion at the first charging station by a plurality of electrified vehicles responding to a request for execution of the electric power control, and
sets an incentive for each of the electrified vehicles to perform the electric power control at the second charging station when determination is made that congestion is occurring at the first charging station.
